(19) United States
(12) Patent Application Publication
(10) Pub. No.: US 2010/0259462 A1
(43) Pub. Date: Oct. 14, 2010

(54) ANGLE ADJUSTMENT APPARATUS OF DISH ANTENNA AND DISH ANTENNA USING THE SAME

(75) Inventor: CHAO CHUN YEH, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: MICROELECTRONICS TECHNOLOGY INC., HSINCHU (TW)

(21) Appl. No.: 12/725,023

(22) Filed: Mar. 16, 2010

(30) Foreign Application Priority Data
Apr. 8, 2009 (TW) 098111614

(51) Int. Cl. H01Q 3/02

(52) U.S. Cl. 343/882

(57) ABSTRACT

An angle adjustment apparatus for a dish antenna comprises a base, a first rotating frame, and a second rotating frame. The first rotating frame is fixed to the second rotating frame, and can rotate around the second rotating frame with a first rotating angle. The second rotating frame is fixed to the base, and can rotate around the base with a second rotating angle. The first rotating frame comprises at least one first arc-shaped slot, and the second rotating frame comprises at least one second arc-shaped slot corresponding to the first arc-shaped slot. A fastener passes through the first arc-shaped slot and the second arc-shaped slot so as to attach the first rotating frame and the second rotating frame.

### BACKGROUND OF THE INVENTION

1. Field of the Invention

The present invention is related to an angle adjustment apparatus of a dish antenna, and more specifically, to an adjustment apparatus for the tuning of the dish antenna angle using screws.

2. Description of Related Art

A satellite television system employs a dish antenna to collect satellite signals, and the signals are then reflected to low noise block down converters (LNB) positioned at the focus of the dish antenna for amplifying the signals and reducing their frequencies down to around 1 GHz, i.e., the radio signals are transformed to an intermediate frequency. The adjusted signals are transmitted via a cable to an indoor television channel selector for selecting the signals of a desired channel, and the selected signals are then amplified, modulated and converted into video and audio signals for television viewing.

A dish antenna is a highly directional receiving device, which must be precisely directed toward satellites in orbit at an altitude of 36,000 kilometers. For example, if a dish antenna with a 180 cm diameter shifts 2 cm horizontally, or 3 cm vertically, the signals will become weak or even disappear. In addition, if a dish antenna uses the Ka band, i.e., 26-40 GHz, an adjustment accuracy of 0.1 degrees is needed, and the tolerance has to be within 0.02 degrees for aiming at satellites precisely.

Normally, a dish antenna using the Ka band is adjusted by using a programmable logic controller (PLC) in control of servo motors; however, the high cost significantly limits its popularity.

FIG. 1 illustrates a known adjustable antenna apparatus 1 including a dish antenna 10, an LNB 11, a support rod 12, an adjustable dish bracket 13 and an adjustable base member 14. As the adjustable antenna apparatus 1 can be disposed by securing the adjustable base member 14 at different places such as on a vertical wall surface or a horizontal or inclined roof, the adjustable dish bracket 13 is used for adjusting the orientation of the dish antenna 10 to obtain optimal signal-reception performance. However, the adjustable dish bracket 13 only approximately adjusts the angle of elevation or the fixing position of the dish antenna 10 according to a scale around an elongated slot engaged with a screw. Because the antenna apparatus 1 has a highly directional requirement, it is adjusted to properly mount on a building in a vertical, horizontal, or inclined manner. In this regard, the elongated slot of the adjustable dish bracket 13 needs to have a sufficient length; otherwise, the dish antenna 10 cannot be easily adjusted to an optimal angle or position.

However, if the elongated slot of the adjustable dish bracket 13 is too long, its structural strength is affected. If the body of the adjustable dish bracket 13 is enlarged in order to increase the structural strength, the manufacturing cost is also increased, and the larger volume presents positioning limitations.

### SUMMARY OF THE INVENTION

The present invention provides an angle adjustment apparatus for a dish antenna, which comprises a pair of elongated slots for adjusting the fixing angle of the dish antenna. Such an angle adjustment apparatus provides the dish antenna with a wide range for angle adjustment so as to be adjusted to properly mount on a building in a vertical, horizontal, or inclined manner.

In accordance with an embodiment of the present invention, an angle adjustment apparatus for a dish antenna comprises a base, a first rotating frame, and a second rotating frame. The first rotating frame is fixed to the second rotating frame, and can rotate around the second rotating frame with a first rotating angle. The second rotating frame is fixed to the base, and can rotate around the base with a second rotating angle. The first rotating frame comprises at least one first arc-shaped slot, and the second rotating frame comprises at least one second arc-shaped slot corresponding to the first arc-shaped slot. A fastener passes through the first arc-shaped slot and the second arc-shaped slot so as to attach the first rotating frame and the second rotating frame.

In accordance with another embodiment of the present invention, a dish antenna apparatus comprises a dish, an angle adjustment apparatus, a support frame, and an adjustable stand. The dish is mounted on the angle adjustment apparatus, and the support frame connects the angle adjustment apparatus and the adjustable stand. The angle adjustment apparatus comprises a base, a first rotating frame, and a second rotating frame. The first rotating frame is fixed to the second rotating frame, and can rotate around the second rotating frame with a first rotating angle. The second rotating frame is fixed to the base, and can rotate around the base with a second rotating angle. The first rotating frame comprises at least one first arc-shaped slot, and the second rotating frame comprises at least one second arc-shaped slot corresponding to the first arc-shaped slot. A fastener passes through the first arc-shaped slot and the second arc-shaped slot so as to attach the first rotating frame and the second rotating frame.

### BRIEF DESCRIPTION OF THE DRAWINGS

FIG. 1 shows a known adjustable antenna apparatus;

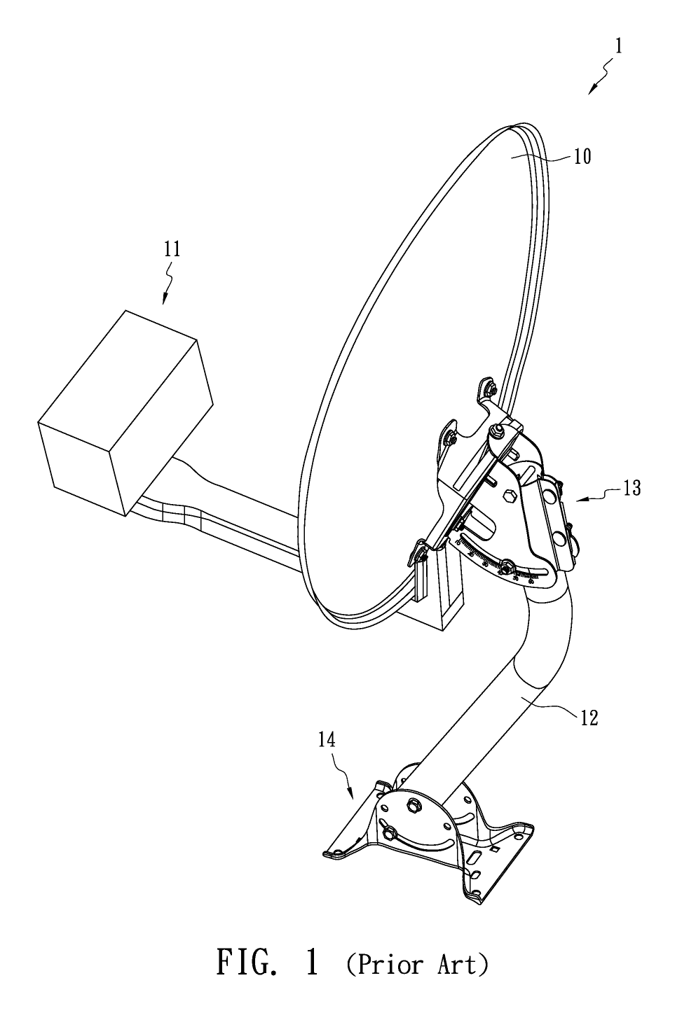

FIG. 2 shows a dish antenna apparatus in accordance with one embodiment of the present invention;

FIG. 3 shows an angle adjustment apparatus of the present invention; and

FIGS. 4A to 4C show changes in the relative positions of the first rotating frame and the second rotating frame in accordance with one embodiment of the present invention.

### DETAILED DESCRIPTION OF THE INVENTION

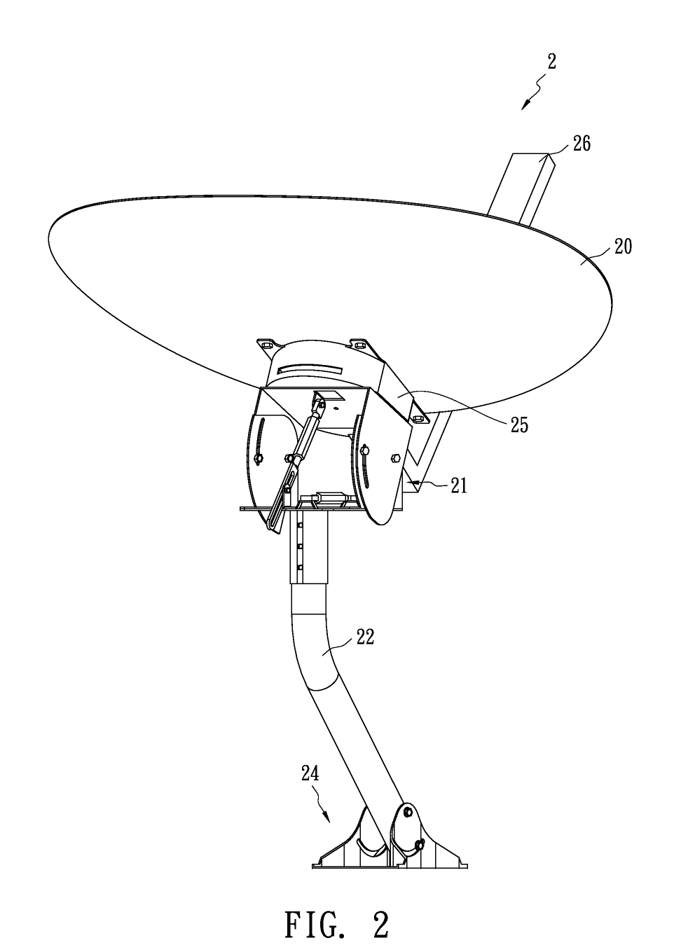

FIG. 2 shows a perspective view of a dish antenna apparatus according to an embodiment of the present invention. A dish antenna apparatus 2 includes a dish antenna 20, an angle adjustment apparatus 21, a support rod 22 and an adjustable base member 24. The dish antenna 20 is secured to the angle adjustment apparatus 21 by a dish bracket 25, and the angle adjustment apparatus 21 is configured to adjust the angles of the dish antenna 20 in two directions which are approximately perpendicular to each other. An LNB rod 26 is secured to a side of the dish bracket 25. The support rod 22 connects the angle adjustment apparatus 21 and the adjustable base member 24. The dish antenna apparatus 2 can be disposed by securing the adjustable base member 24 at different places such as a vertical wall surface or a horizontal or inclined roof, and the angle adjustment apparatus 21 can adjust the orientation of the dish antenna 20 for obtaining optimal transmission performance.

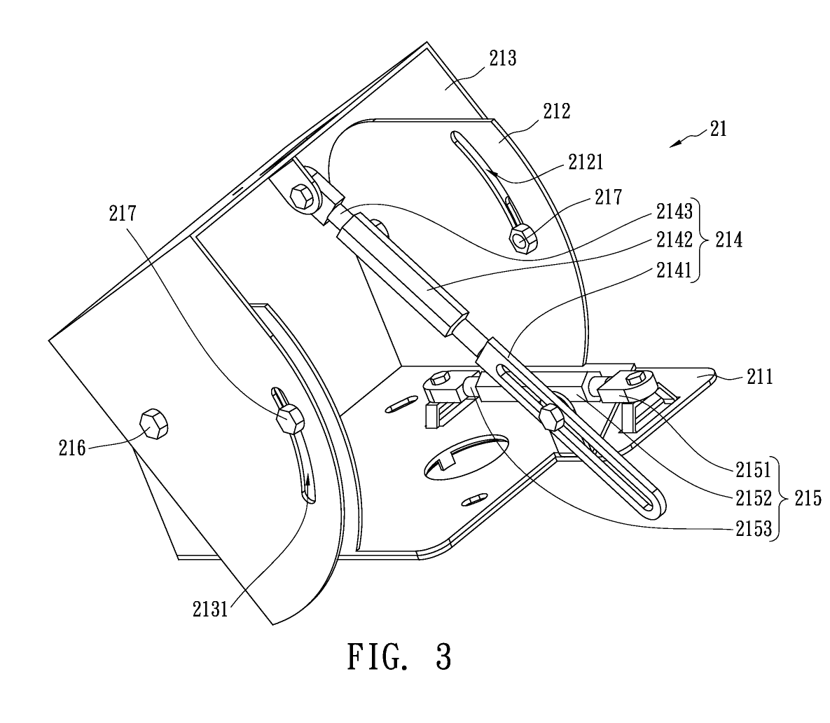

FIG. 3 shows the perspective view of an angle adjustment apparatus in accordance with the present invention. The angle adjustment apparatus 21 includes a base member 211, a first rotation member 213, a second rotation member 212, a first rotating angle adjustment mechanism 214 and a second rotating angle adjustment mechanism 215. The first rotation member 213 is secured to the second rotation member 212, and has a relative rotation movement around the second rotation member 212 in a first rotation angle. The second rotating frame 212 is fixed to the base member 211, and can rotate around the base 211 with a second rotating angle. That is, the second rotating frame 212 rotates along the direction perpendicular to the base member 211.

The first rotating frame 213 comprises at least one first arc-shaped slot 2131. In this embodiment, the first rotating frame 213 has a pair of first arc-shaped slots 2131 symmetrically arranged. The second rotating frame 212 comprises at least one second arc-shaped slot 2131 corresponding to the first arc-shaped slot 2121. In this embodiment, the second rotating frame 212 has a pair of second arc-shaped slots 2121 symmetrically arranged. A fastener 217 passes through the first arc-shaped slot 2131 and the second arc-shaped slot 2121 so as to attach the first rotating frame 213 and the second rotating frame 212. By adjusting the relative positions of the first arc-shaped slot 2131 and the second arc-shaped slot 2121, the first rotation angle is changed. Moreover, the first arc-shaped slot 2131 and the second arc-shaped slot 2121 rotate around the pivot 216, and can separate from each other or overlap each other.

The first rotating angle adjustment mechanism 214 comprises a first screw rod 2141, a screw nut post 2142, and a second screw rod 2143. A fixed end of the first screw rod 2141 is fixed to the first rotating frame 212, and the other end is equipped with first threads and engaged with the first inner threads of the screw nut post 2142. The relative positions of the first arc-shaped slot 2131 and the second arc-shaped slot 2121 can be adjusted by changing the length of the first rotating angle adjustment mechanism 214. When the optimal relative positions are obtained, the first rotation member 213 and the second rotation member 212 are fixed together by tightening the fastener 217. That is, the range of a rotating angle of the first rotating frame 213 relative to the second rotating frame 212 is the sum of the arc angles of the first arc-shaped slot 2131 and the second arc-shaped slot 2121 relative to the pivot 216.

The second rotating angle adjustment mechanism 215 comprises two screw rods 2151, 2153 and the screw nut post 2152. Two ends of the two screw rods 2151 and 2153 distal from each other are respectively pivoted on the base member 211 and the second rotating frame 212, and the other two ends of the two screw rods 2151 and 2153 proximal to each other and equipped with threads are engaged with the screw nut post 2152. When the total length of the second rotating angle adjustment mechanism 215 is changed, the angle of the second rotation member 212 relative to the base member 211 is also adjusted.

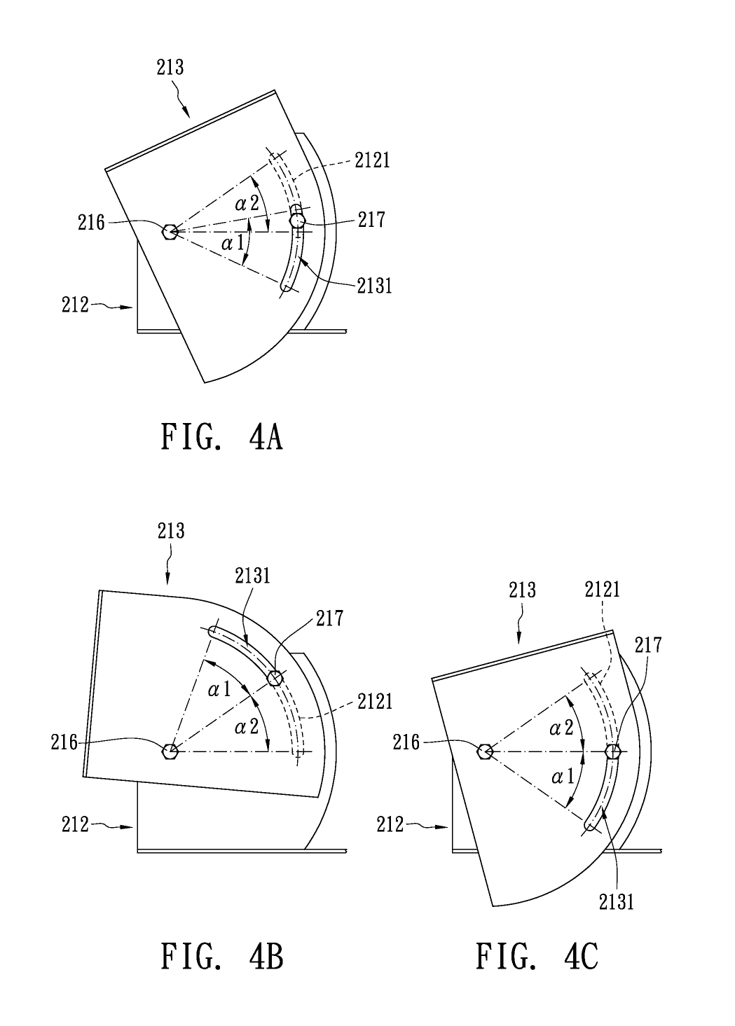

FIGS. 4A to 4C show changes in the relative positions of the first rotating frame and the second rotating frame in accordance with an embodiment of the present invention. As shown in FIG. 4A, the first arc-shaped slot 2131 and the second arc-shaped slot 2121 respectively have arc angles α1 and α2 relative to the pivot 216. The first arc-shaped slot 2131 and the second arc-shaped slot 2121 partially overlap each other. FIG. 4B shows the first rotating frame 213 and the second rotating frame 212 far from each other at the greatest separation distance. FIG. 4C shows the first rotating frame 213 and the second rotating frame 212 close to each other at the smallest separation distance. Referring to these drawings, the adjustment angle between the first rotating frame 213 and the second rotating frame 212 ranges from 0 degree to (α1+α2). The adjustment angle is dramatically increased so the disk antenna is easily suitable for mounting in various positions. That is, the range of a rotating angle of the first rotating frame 213 relative to the second rotating frame 212 is the sum of the arc angles of the first arc-shaped slot 2131 and the second arc-shaped slot 2121 relative to the pivot 216.

The above-described embodiments of the present invention are intended to be illustrative only. Numerous alternative embodiments may be devised by those skilled in the art without departing from the scope of the following claims.

What is claimed is:

1. An angle adjustment apparatus for a dish antenna, comprising:
a base;
a first rotating frame including at least one first arc-shaped slot; and
a second rotating frame including at least one second arc-shaped slot corresponding to the first arc-shaped slot and fixed to the base;
whereby the first arc-shaped slot and the second arc-shaped slot are linked together to combine the first rotating frame and the second rotating frame.

2. The angle adjustment apparatus for a dish antenna of claim 1, further comprising a first rotation angle adjustment mechanism whose two ends are respectively fixed to the first rotating frame and the second rotating frame, whereby the length of the first rotating angle adjustment mechanism is changed to adjust the relative positions of the first arc-shaped slot and the second arc-shaped slot.

3. The angle adjustment apparatus for a dish antenna of claim 1, further comprising a fastener passing through the first arc-shaped slot and the second arc-shaped slot to attach the first rotating frame and the second rotating frame.

4. The angle adjustment apparatus for a dish antenna of claim 1, wherein the first rotating frame and the second rotating frame rotate around a pivot, and the first arc-shaped slot and the second arc-shaped slot rotate around the pivot.

5. The angle adjustment apparatus for a dish antenna of claim 4, wherein the range of a rotating angle of the first rotating frame relative to the second rotating frame is the sum of the arc angles of the first arc-shaped slot and the second arc-shaped slot relative to the pivot.

6. The angle adjustment apparatus for a dish antenna of claim 1, further comprising a second rotating angle adjustment mechanism whose two ends are respectively fixed to the base and the second rotating frame.

7. A dish antenna apparatus, comprising:
an angle adjustment apparatus, comprising:
a base;
a first rotating frame including at least one first arc-shaped slot; and
a second rotating frame including at least one second arc-shaped slot corresponding to the first arc-shaped slot and fixed to the base;
a dish mounted on the angle adjustment apparatus;
an adjustable stand; and
a support frame connecting the angle adjustment apparatus and the adjustable stand.

8. The dish antenna apparatus of claim 7, further comprising a first rotation angle adjustment mechanism whose two ends are respectively fixed to the first rotating frame and the second rotating frame, whereby the length of the first rotating angle adjustment mechanism is changed to adjust the relative positions of the first arc-shaped slot and the second arc-shaped slot.

9. The dish antenna apparatus of claim 7, further comprising a fastener passing through the first arc-shaped slot and the second arc-shaped slot to attach the first rotating frame and the second rotating frame.

10. The dish antenna apparatus of claim 7, wherein the first rotating frame and the second rotating frame rotate around a pivot, and the first arc-shaped slot and the second arc-shaped slot rotate around the pivot.

11. The dish antenna apparatus of claim 10, wherein the range of a rotating angle of the first rotating frame relative to the second rotating frame is the sum of the arc angles of the first arc-shaped slot and the second arc-shaped slot relative to the pivot.

12. The dish antenna apparatus of claim 7, further comprising a second rotating angle adjustment mechanism whose two ends are respectively fixed to the base and the second rotating frame.
